(19) United States
(12) Patent Application Publication
(10) Pub. No.: US 2018/0341907 A1
(43) Pub. Date: Nov. 29, 2018

(54) CROWDSOURCING TECHNIQUES FOR PROCESSING PRODUCT CONTENT

(71) Applicant: Walmart Apollo, LLC, Bentonville, AR (US)

(72) Inventors: Benjamin Tucker, Bella Vista, AR (US); Gregory White, Cincinnati, OH (US); Jason Bowden, Bentonville, AR (US); Saravanan Manickam, Bentonville, AR (US); David Terjak, Cave Springs, AR (US)

(21) Appl. No.: 15/984,982

(22) Filed: May 21, 2018

Related U.S. Application Data
(60) Provisional application No. 62/511,736, filed on May 26, 2017.

(51) Int. Cl. G06Q 10/08; G06Q 30/06; G06K 9/46; G06K 9/20; H04M 1/02

(52) U.S. Cl. CPC G06Q 10/087; G06Q 30/0623; H04M 1/0264; G06K 9/2063; G06K 9/4671

(57) ABSTRACT

A system and method for populating a store product information repository with information-rich content comprises capturing, by a sensor device, image data from a product of interest; executing an image recognition process to extract information-rich content from the captured image data in the form of text or graphics; outputting the extracted relevant content to a generic product description attribute; mapping the generic product description attribute to a product record; and storing the product record including the information-rich content for populating a product information repository.

### RELATED APPLICATIONS

This application claims the benefit of U.S. Provisional Patent Application No. 62/511,736, filed May 26, 2017 and entitled “Crowdsourcing Techniques for Processing Product Content,” the contents of which are incorporated herein in their entirety.

### TECHNICAL FIELD

The present inventive concepts relate generally to electronically-stored information regarding retail items, and more specifically, to systems and crowdsourcing techniques for processing rich digital content for an information source.

### BACKGROUND

Modern retail establishments, including but not limited to brick-and-mortar stores and online e-commerce stores, have access to content databases for storing information about offered items and services. Content databases may store varying amounts of information on thousands, or even tens of thousands, of store items. Some store item data records may include insufficient information about the corresponding store items, which reduces the amount of information on the store items when published or otherwise presented at a store website or other information repository.

### SUMMARY

In one aspect, provided is a method for populating a store product information repository with information-rich content, comprising: capturing, by a sensor device, image data from a product of interest; executing an image recognition process to extract information-rich content from the captured image data in the form of text or graphics; outputting the extracted relevant content to a generic product description attribute; mapping the generic product description attribute to a product record; and storing the product record including the information-rich content for populating a product information repository.

In some embodiments, the sensor device is a digital camera for capturing the image data. In some embodiments, the digital camera is a modular plug-in digital camera.

In some embodiments, mapping a generic product description attribute to a product record comprises executing the image recognition process to extract text or graphics from images and mapping to a generic product description attribute then performing a search of an information repository for the product record.

In some embodiments, executing the image recognition process comprises: isolating text from non-text regions of the captured image data; mapping the text to a string; and storing the mapped text as a generic value.

In some embodiments, the method further comprises applying deep learning to the image extraction step of the image recognition process to actively identify key product branding by performing corner and Scale Invariant Feature Transform (SIFT) matching and color matching based on pixel analysis as compared against a pre-training product logo data store.

In some embodiments, the method further comprises creating a new record with the generic product description attribute in response to the search failing to identify the product in the store product information.

In some embodiments, the product information repository includes a catalog of store items or services stored electronically at the product information repository.

In some embodiments, the information-rich content is collected in response to manual entry of the content to a computer.

In some embodiments, the method further comprises adding the product to the store product information repository with the created new record.

In some embodiments, the method further comprises adding additional attributes regarding the product to the new record.

In some embodiments, the method further comprises publishing the information-rich content to an e-commerce website or digital catalog.

In some embodiments, for the graphics, the method further comprises recognizing the graphics based on a constant feature variance, and identifying the graphics for association with the product of interest.

In one aspect, provided is a system for populating a store product information repository with information-rich content, comprising: an image recognition processor that extracts relevant text from information-rich content collected from a store product, and that outputs the extracted relevant text to a generic product description attribute; a search engine that performs a search of a store product information repository for a record of the store product using the extracted relevant text; and a machine learning-based attribute mapping processor that either adds the information-rich content to a field to the record in response to the search engine identifying the product in the store product information repository or creates a new record with the generic product description attribute in response to the search failing to identify the product in the store product information.

In some embodiments, the system further comprises a sensor device that captures image data from the store product, wherein the information-rich content is collected from the captured image data.

In some embodiments, the machine learning-based attribute mapping processor maps the generic product description attribute to a product record and executes an image recognition process to extract text from images and map to the generic product description attribute.

In some embodiments, the machine learning-based attribute mapping processor creates the new record with the generic product description attribute in response to the search failing to identify the product in the store product information.

In some embodiments, the system further comprises a notification generator that generates and outputs a notification in response to the product content being acquired and saved in a product database, the notification information notifying a recipient whether to publish the information-rich content.

### BRIEF DESCRIPTION OF THE DRAWINGS

Advantages of examples of the present inventive concepts may be better understood by referring to the following description in conjunction with the accompanying drawings, in which like numerals indicate like structural elements and features in various figures. The drawings are not necessarily to scale, emphasis instead being placed upon illustrating the principles of features and implementations.

FIG. 1 is a high-level network diagram illustrating some embodiments in which the present inventive concepts may be practiced.

FIG. 2 is a block diagram of an attribute generation processor, in accordance with some embodiments.

FIG. 3 is a high-level flow diagram of a method for populating a data repository with store item product information, in accordance with some embodiments.

FIG. 4 is a flow diagram illustrating a method for crowdsourcing product content, in accordance with some embodiments.

FIG. 5 is an illustrative view of a mobile electronic device capturing rich content from a store product, in accordance with some embodiments.

FIG. 6 is a screenshot of a user interface displaying a list of store products requiring rich content, in accordance with some embodiments.

FIG. 7 is a screenshot of a user interface displaying a list of potential matches in response to a search result.

### DETAILED DESCRIPTION OF EMBODIMENTS

In brief overview, a smartphone plugin module including a high resolution camera or other sensor is provided to capture images of store items for the purpose of collecting rich content related to the product. Crowdsourcing methods may be applied. The user of the smartphone or related mobile device may receive incentives from the store, product manufacturer, or other authorized source to provide the camera images to a system, which extracts relevant content from the images and adds them to a stored record on the product, which may subsequently be processed for use to populate a description of an existing store item in, or add a new store item to, a website, online product catalog, and so on.

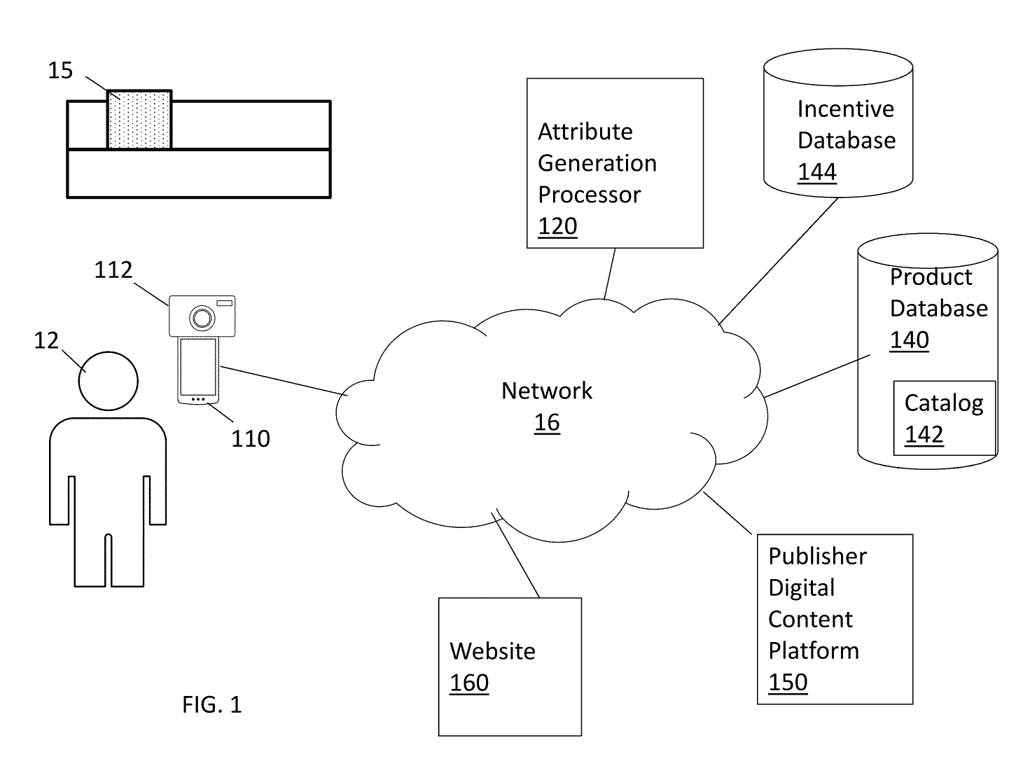

FIG. 1 is a high-level network diagram illustrating an embodiment in which the present inventive concepts may be practiced. A customer mobile electronic device 110, attribute generation processor 120, product database 140, publisher digital content platform 150, and website 160 may communicate with each other and/or other electronic devices not shown in FIG. 1 via a network 16 for performing operations according to embodiments of the present inventive concepts. The network 16 may be a local area network (LAN), a wide area network (WAN), wireless network, and/or any other electronic communication exchange environment. In some embodiments, the network 16 includes a cloud computing network or the like.

The mobile electronic device 110 may be a personal computer such as a smartphone, electronic notebook, laptop computer, and so on. The mobile electronic device 110 may include an integrated camera and/or other sensing device. In some embodiments, the mobile electronic device 110 includes an interface for electronically communicating with a snap-on or modular camera provided by the retail establishment, marketing firm, or other entity or party interested in collecting rich content, or rich media including information comprising any combination of text, images, audio, video, and/or multimedia regarding products of interest. Here, the snap-on camera may be provided or the customer's personal camera may be used as part of a crowdsource program, wherein store customers are incentivized to collect such product data by capturing images of store products on shelves or the like, which may include the rich content desired by the store or other interested party. Another crowd-sourcing aspect is that the content curation process of scanning the image and submitting to the product store is initialized via an end user on a mobile device.

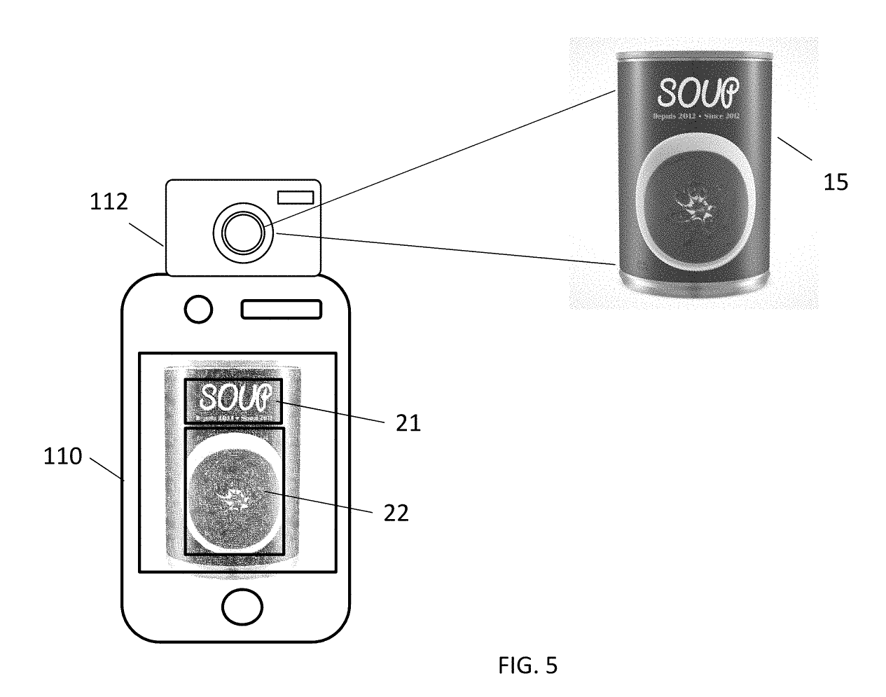

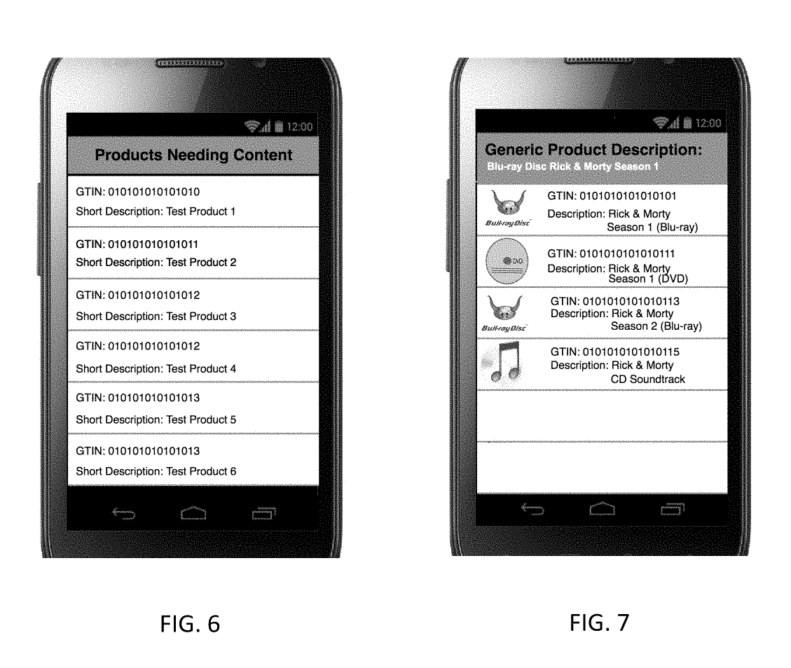

The attribute generation processor 120 executes an attribute extraction process on images, text, graphics, and/or other information-rich content captured by a user's camera or related sensor, and maps the extracted text, graphics, and/or other visual information to generate a product description attribute, e.g., part of a record stored at the product database 140 for a product of interest 15, which may be used to perform a subsequent search for the product 15 to which the extracted content pertains. Extracted content preferably includes rich content that describes the product 15 such as product descriptions, assembled dimensions, category-specific attributes such as battery type, memory size, shirt size, etc. For example, as shown in FIG. 5, an image of a product 15, in particular, a brand of soup, may produce text content 21 such as “Soup Since 2002,” and an image 22 of a bowl of soup, which can be captured, processed, and subsequently added to a website that displays information about the product 15, i.e., the brand of soup.

The product database 140 may store a product catalog 142 populated with database records or the like for each product, including one or more generic attribute fields as well as mapping relationships between the generic attribute fields and various source-specific product attributes specified by the product catalog 142. The product catalog 142 may map the various source-specific attributes associated with particular products to the generic attributes specified by the global product catalog for those products. Thus, the product catalog 142 may provide information regarding products and services that may be used to populate a website, e-commerce location, digital product catalog, electronic display, online advertisements, and so on.

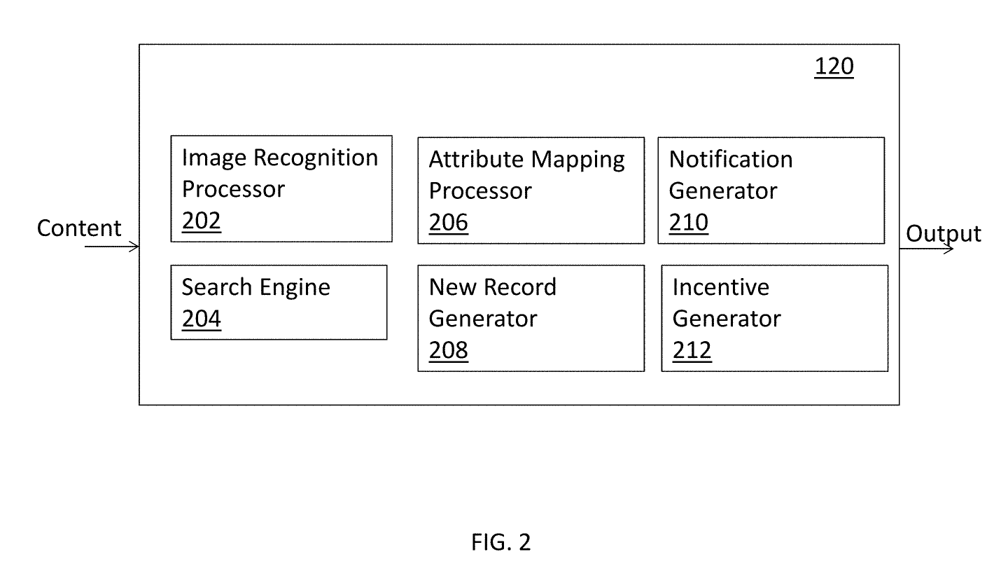

Referring to FIG. 2, in some embodiments, the attribute generation processor 120 includes an image recognition processor 202, a search engine 204, an attribute mapping processor 206, a new record generator 208, a notification generator 210, and an incentive generator 212. Some or all of the image recognition processor 202, a search engine 204, attribute mapping processor 206, new record generator 208, notification generator 210, and an incentive generator 212 may be co-located at a same computer platform, for example, stored in a common computer memory and executed by a same hardware processor, or located at different computer platforms that communicate with each other via the network 16.

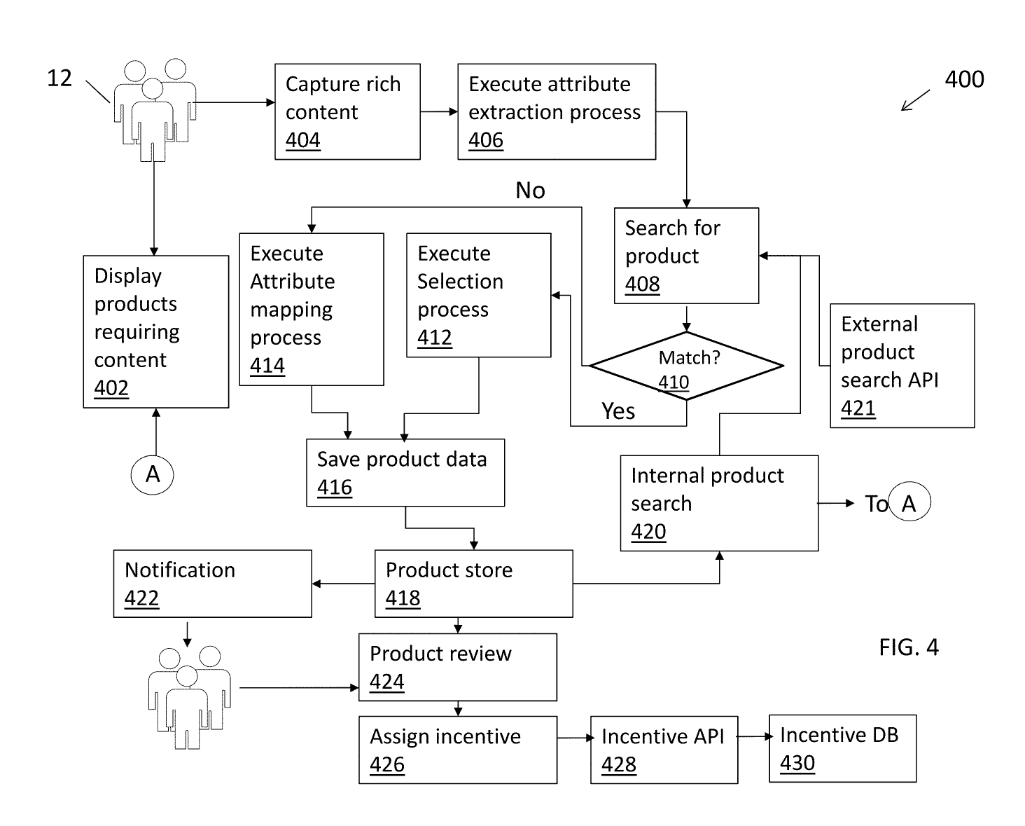

The image recognition processor 202 receives an input of rich content information such as product images captured by a mobile device camera 112 or related sensor device, or received from a manual input by a user 12 assigned to perform the task of collecting images of various products of interest, for example, applying crowdsourcing techniques, and executes an image recognition process to extract text and/or visual information in a predetermined format, such as a text-based format, and outputs the extracted text and/or visual information into a generic product description attribute. In some embodiments, a description attribute functions as a “catch-all” attribute, for example, implemented in cases where a search for text cannot occur via a deep matching association to a more specific attribute, for example, performed by the new record generator 208. If such a deep matching association does not occur, then text may be saved in a generic “unprocessed product description” attribute. The user then transfers the text data, using the new record generator 208, to a correct or otherwise identified field, or submits the text data to be filtered later by a user, for example, a member of a content curation team described at step 424 of FIG. 4. In addition to extracting text (characters, etc.), portions of the image and or other information from the captured images may be processed, for example, stored at the product database 140.

In some examples, the image recognition processor 202 is configured to recognize a targeted category, for example, identify specific content. A deep matching technique may be executed in the product store repository to match to a given product within a specified variance threshold. If more than one product is identified by the search engine 204, the results may be displayed for a user to manually select a result from the list of results. In addition to extracting the text, the image or portions of the image itself could also be saved in the product store, or saved in an associated digital asset management system and related to the product store via URL or other identifier.

The search engine 204 is configured to perform a search for products of which images were captured by the mobile device camera 112 in order to generate an association between the generic product description attribute generated by the image recognition processor 202 and the product itself. The search engine 204 may search the product database 140 and/or other product repositories, such as a store database, and/or include an external product application programming interface (API) to identify the scanned product at remote storage locations. The intent here is that relevant identifiers such as brand, primary product description, barcode, and so on can be captured via the image extraction process. These key data points can then be passed into the internal product search API as search parameters. In some embodiments, external product APIs, for example, Google Shopping API, AWS Product Search, IBM Search, Indix, Algolia, or other APIs may be used for product discovery purposes, and also perform similar attribution processes and return similar results.

The attribute mapping processor 206 is configured to map a generic product description attribute to a product that does not have a corresponding record stored in the product repository 140, for example, in response to the search failing to identify the product 15 in the store product information. The attribute mapping processor 206 may execute a machine learning based attribute mapping process to map the extracted text or other captured data to the appropriate internally defined attribute. The new record generator 208 may generate a record in response to a user command.

These persons may be part of a content curation team or other association of one or more individuals who review, update, finalize, and/or reject the captured content.

Referring again to FIG. 1, the product database 140 stores captured product content in an unpublished state, i.e., content acquired from captured images associated with data records of the corresponding product. The product database 140 may be part of a digital asset management system or the like, and its contents may be accessed by a uniform resource locator (URL) or other identifier.

The incentive generator 212 includes a data repository that includes incentive data that assigns an incentive to the user of the mobile electronic device 110 capturing rich content.

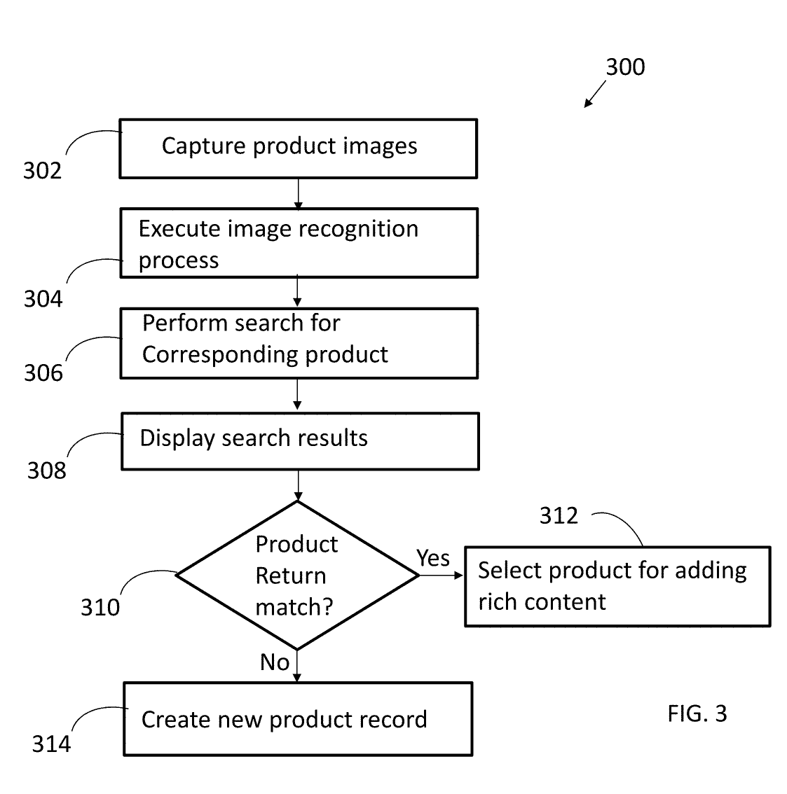

FIG. 3 is a high-level flow diagram of a method 300 for populating a data repository with store item product information, in accordance with some embodiments. Some or all of the method 300 may be executed by elements of the network environment described with reference to FIGS. 1 and 2.

At block 302, at least one image of a product of interest 15 is captured by a digital camera 112 or other image sensing device. The product image(s) can be stored at the mobile electronic device 110 such as a smartphone, computer notebook, and so on. In other embodiments, a user may enter image rich content information to a computer 110 manually, for example, typing information, providing information from a website or other online location, scanning photographs, and so on.

At block 304, an image recognition process is performed, by the attribute generation processor 120, on the captured image(s) to extract relevant text, graphics, or other data elements from the captured or manually entered content. For example, a well-known technique may be executed that detects regions in an image that contain text, and applies optical character recognition (OCR) or the like to recognize and extract text automatically from captured images.

At block 306, a search is performed for a product to which the captured image corresponds. The search engine 204 of the attribute generation processor 120 may search for a record of the product or other identifier at an internal data source such as the product database 140 and/or external sources by executing an external product search API or the like.

At block 308, a list of potential matches is displayed in response to the search performed at block 306, for example, shown in FIG. 7.

At decision diamond 310, the attribute generation processor 120 determines whether a product return match is produced. If yes, then the method 300 proceeds to block 312 where the user can select a product from the match list to which the rich content of the captured image is associated. In doing so, the information is returned from the search in addition to any other information manually added by the user, e.g., typing the information into the mobile device 110, to a record stored at the product database 140 having an empty field that can be populated with the rich content.

If at decision diamond 310 the attribute generation processor 120 does not produce a match, then the method proceeds to block 314, where the attribute generation processor 120 creates a new product record with a given mapped attribute from the scanned image. A machine learning-based attribute mapping process may be run to map the extracted text, graphic, or other rich content to the appropriate internally defined attribute. The user may add, for example, manually enter, other additional attributes not mapped. The new product record can be stored at the product database 140 or other data repository.

FIG. 4 is a flow diagram illustrating a method 400 for crowdsourcing product content, in accordance with some embodiments. Some or all of the method 300 may be executed by elements of the network environment described with reference to FIGS. 1 and 2.

At block 402, a list of products requiring rich content is displayed at the user's mobile electronic device 110. The user may select a product on which the user intends to capture data, and/or the user at block 404 may in response capture an image from a product at the store, or manually enter rich content information at the mobile electronic device 110 in a similar manner as described in block 302 above. Details are not repeated due to brevity.

At block 406, an attribute execution process is executed on the captured image(s) to extract relevant text, graphics, or other data elements. The attribute generation processor 120 can output the extracted text, images, or the like into a generic product description attribute. For example, a well-known technique may be executed that detects regions in an image that contain text, and applies optical character recognition (OCR) or the like to recognize and extract text automatically from captured images. In some embodiments, after isolating text from the non-text regions and performing a stroke width estimation to ensure that the text is consistent, i.e., measuring curves and lines that make up a character, the extracted text can be mapped to a string and stored in the generic value. Additionally, deep learning techniques can be applied to the image extraction process to actively identify key product branding information, for example, to complete the method 400. For example, deep learning to an image extraction step of the image recognition process may be applied to actively identify key product branding by performing corner and Scale Invariant Feature Transform (SIFT) matching and color matching based on pixel analysis as compared against a pre-training product logo data store. For images such as graphics or non-text elements, the image recognition processor 202 is configured to recognize specific logos or types of logos based on constant feature variance, whereby the processor 202 is tuned to recognize specific shapes, color combinations, and so on, for example, the image 22 of a bowl of soup shown displayed on a soup can 15 shown in FIG. 5.

At block 408, the attribute generation processor 120 performs a search for a record of the product using the collected image data. An internal product search 420 and/or external product search 421 may be performed. For example, an internal product search application programming interface (API) executed by a computer processor may be used to perform a search of the internal store product database 140. In addition or alternatively, an external search of a remote database or other product information repository may be performed by executing an external product search API.

At decision diamond 410, the attribute generation processor 120 establishes whether a match is found between the collected image data and contents of the internal and/or external data repositories. If yes, then the method 400 proceeds to block 412 where the user can select a product from the match list to which the rich content of the captured image is associated. At block 416, the information returned from the search in addition to any other information manually added by the user, e.g., typing the information into the mobile device 110, may be saved by a product save API or the like, and at block 418 may be stored at the product database 140. This data stored at the product database 140 may be part of an internal product search (block 420).

If at decision diamond 410 the attribute generation processor 120 does not identify a match, then the method proceeds to block 414, where the attribute generation processor 120 executes an attribute mapping process in an attempt to create a product with the given mapped attribute from the scanned image. At block 416 the information may be saved by a product save API or the like, and at block 418 may be stored at the product database 140. The user may add other additional attributes not mapped, which can likewise be saved and stored. For example, an evolving taxonomy store may be provided that stores hundreds of attributes that the end user may additionally provide content for when prompted. For example, a television may have specific attributes including but not limited to screen width, HDMI, Includes Remote, Smart TV Channel selection (multi-value list including Netflix, Hulu, Vudu, etc.).

At block 422, a notification may be generated electronically, for example, an automatic email or instant message to a predetermined recipient, such as a person or group of people responsible for reviewing the content prior to publishing the content on a website or publicly available display. At block 424, the notification recipient(s) may review the product content, in particular, the text, image, or other data captured and/or manually entered and associated via the method 300 with the product of interest. The notification recipient, or other authorized agent, may update, finalize, and/or reject the content. After review, the content may be published to the identified website or display.

Publishing content to an e-commerce location may include analyzing and parsing the generic description, and performing pattern recognition in the text. For example, seeing a numeral followed by “oz.” or “lb.” would indicate a type of measurement and can be stored in a pre-defined attribute for the product category identified for the item of interest. If nothing of value can be derived from the generic description, it may be manually curated by the internal content curation team (see block 424) that would review the text and populate the values appropriately. Alternately, the end user who crowdsources the data can manually populate the appropriate attributes, and receive an incentive, for example, based on a predetermined agreement that an incentive would be provided if the content is acceptable to the content curation team.

At block 426, the customer 12 collecting the rich content may be assigned an incentive, for example, cash, reward card, gift, and so on. Incentive-related data and corresponding assignees of incentives may be stored at an incentive store, such as a database 144 or the like.

Referring again to FIG. 1, in some embodiments, the attribute generation processor 120, content platform 150, website 160, and/or other elements of the environment may be part of a computer system, which includes but is not limited to a processor, and input/output and memory devices each electronically and conductively coupled to the processor. For example, the attribute generation processor 120 may perform computations and control the functions of a computer, including executing instructions included in the computer code for the tools and programs capable of implementing a method for processing a purchase of unavailable merchandise, in the manner prescribed by the embodiments of FIGS. 3 and 4 using the environment of FIG. 1, wherein the instructions of the computer code may be executed by processor via memory device. The computer code may include software or program instructions that may implement one or more algorithms for implementing the methods for processing a purchase of unavailable merchandise, as described in detail above. The processor executes the computer code. The attribute generation processor 120, content platform 150, website 160, and/or other elements of the environment may include a single processing unit, or may be distributed across one or more processing units in one or more locations (e.g., on a client and server).

The memory device may be used as a computer-usable storage medium (or program storage device) having a computer-readable program embodied therein and/or having other data stored therein, wherein the computer-readable program comprises the computer code. Generally, a computer program product (or, alternatively, an article of manufacture) of the computer system may comprise said computer-usable storage medium (or said program storage device).

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to systems and methods for processing a purchase of unavailable merchandise. Thus, an embodiment of the present invention discloses a process for supporting computer infrastructure, where the process includes providing at least one support service for at least one of integrating, hosting, maintaining and deploying computer-readable code in a computer system including one or more processors, wherein the processor carries out instructions contained in the computer code causing the computer system to process a purchase of unavailable merchandise in accordance with embodiments of the present invention. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method for processing a purchase of unavailable merchandise. Thus, the present invention discloses a process for supporting, deploying and/or integrating computer infrastructure, and integrating, hosting, maintaining, and deploying computer-readable code into the system, wherein the code in combination with the system is capable of performing a method for processing a purchase of unavailable merchandise.

A computer program product of the present invention comprises one or more computer-readable hardware storage devices having computer-readable program code stored therein, the program code containing instructions executable by one or more processors of a computer system to implement the methods of the present invention.

A computer system of the present invention comprises one or more processors, one or more memories, and one or more computer-readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein

What is claimed is:

1. A method for populating a store product information repository with information-rich content, comprising:
capturing, by a sensor device, image data from a product of interest;
executing an image recognition process to extract information-rich content from the captured image data in the form of text or graphics;
outputting the extracted relevant content to a generic product description attribute;
mapping the generic product description attribute to a product record; and
storing the product record including the information-rich content for populating a product information repository.

2. The method of claim 1, wherein the sensor device is a digital camera for capturing the image data.

3. The method of claim 2, wherein the digital camera is a modular plug-in digital camera.

4. The method of claim 1, wherein mapping a generic product description attribute to a product record comprises executing the image recognition process to extract text or graphics from images and map to a generic product description attribute then performing a search of an information repository for the product record.

5. The method of claim 4, wherein executing the image recognition process comprises:
isolating text from non-text regions of the captured image data;
mapping the text to a string; and
storing the mapped text as a generic value.

6. The method of claim 5, further comprising: applying deep learning to the image extraction step of the image recognition process to actively identify key product branding by performing corner and Scale Invariant Feature Transform (SIFT) matching and color matching based on pixel analysis as compared against a pre-training product logo data store.

7. The method of claim 1, further comprising creating a new record with the generic product description attribute in response to the search failing to identify the product in the store product information.

8. The method of claim 1, wherein the product information repository includes a catalog of store items or services stored electronically at the product information repository.

9. The method of claim 1, wherein the information-rich content is collected in response to manual entry of the content to a computer.

10. The method of claim 1, wherein the information-rich content is collected by performing a crowdsourcing process.

11. The method of claim 1, further comprising: adding the product to the store product information repository with the new record.

12. The method of claim 11, further comprising: adding additional attributes regarding the product to the new record.

13. The method of claim 1, further comprising:
publishing the information-rich content to an e-commerce website or digital catalog.

14. The method of claim 1, wherein for the graphics, the method further comprises recognizing the graphics based on a constant feature variance, and identifying the graphics for association with the product of interest.

15. A system for populating a store product information repository with information-rich content, comprising:
an image recognition processor that extracts relevant text from information-rich content collected from a store product, and that outputs the extracted relevant text to a generic product description attribute;
a search engine that performs a search of a store product information repository for a record of the store product using the extracted relevant text; and
a machine learning-based attribute mapping processor that either adds the information-rich content to a field to the record in response to the search engine identifying the product in the store product information repository or creates a new record with the generic product description attribute in response to the search failing to identify the product in the store product information.

16. The system of claim 14, further comprising a sensor device that captures image data from the store product, wherein the information-rich content is collected from the captured image data.

17. The system of claim 14, wherein the machine learning-based attribute mapping processor maps the generic product description attribute to a product record and executes an image recognition process to extract text or graphics from images and map to the generic product description attribute.

18. The system of claim 14, wherein the machine learning-based attribute mapping processor creates the new record with the generic product description attribute in response to the search failing to identify the product in the store product information.

19. The system of claim 14, further comprising a notification generator that generates and outputs a notification in response to the product content being acquired and saved in a product database, the notification information notifying a recipient whether to publish the information-rich content.

20. The system of claim 14, wherein for the graphics, the method further comprises recognizing the graphics based on a constant feature variance, and identifying the graphics for association with the product of interest.
